(19) United States
(12) Patent Application Publication
(10) Pub. No.: US 2016/0042636 A1
(43) Pub. Date: Feb. 11, 2016

(54) ELECTRONIC DEVICE AND METHOD FOR TURNING OFF ALARM FOR ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: SHI-QIANG ZHU, Shenzhen (CN); SAI-RONG HUANG, Shenzhen (CN); ZHI-GUO LI, Shenzhen (CN); XIAO-BO FENG, Shenzhen (CN)

(21) Appl. No.: 14/693,229

(22) Filed: Apr. 22, 2015

(30) Foreign Application Priority Data
Aug. 8, 2014 (CN) 201410388462.5

(51) Int. Cl. G08B 25/00; G01J 1/42

(52) U.S. Cl. CPC G08B 25/008; G01J 1/4204

(57) ABSTRACT

An alarm control method for turning off an alarm for an electronic device includes the following steps: detecting that an alarm by an alarm unit of an electronic device being activated; converting an intensity of prevailing ambient light directed by an optical sensor of the electronic device to ambient light signals; determining whether an ambient light value has changed based on the ambient light signals; and determining whether a change in the ambient light value is equal to or greater than a first predetermined value if the ambient light value has changed, and in event turning off upon such determination. An electronic device using the method is also provided.

### CROSS-REFERENCE TO RELATED APPLICATIONS

This application claims priority to Chinese Patent Application No. 201410388462.5 filed on Aug. 8, 2014, the contents of which are incorporated by reference herein.

### FIELD

The subject matter herein generally relates to electronic devices and methods for turning off alarm for electronic devices, and particularly to an electronic device and a method for turning off an alarm based light changes around the electronic device.

### BACKGROUND

Electronic devices having alarms, such as mobile phones, digital photo frames, electronic readers (e-reader), for example, are popular. Conventional methods for powering off an alarm for electronic devices are to depress a mechanical button arranged on the electronic device, or touching a virtual button displayed on a touch screen of the electronic device.

### BRIEF DESCRIPTION OF THE DRAWINGS

Implementations of the present technology will now be described, by way of example only, with reference to the attached figures.

FIG. 1 is a block diagram of one embodiment of an electronic device including an alarm control system.

FIG. 2 is a flowchart of an alarm control method for turning off an alarm, for the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented. It should be noted that references to “an” or “one” embodiment in this disclosure are not necessarily to the same embodiment, and such references mean “at least one.”

The word “module”, “unit” as used hereinafter, refers to logic embodied in hardware or firmware, or to a collection of software instructions, written in a programming language, such as, for example, Java, C, or assembly. One or more software instructions in the modules may be embedded in firmware, such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. Some non-limiting examples of non-transitory computer-readable media include CDs, DVDs, BLU-RAY, flash memory, and hard disk drives. The term “comprising,” when utilized, means “including, but not necessarily limited to”; it specifically indicates open-ended inclusion or membership in the so-described combination, group, series and the like.

The present disclosure is described in relation to an electronic device and an alarm control method for turning off an alarm. The method includes the following steps: detecting, by a processor, that an alarm created by an alarm unit of an electronic device is activated; converting, by the processor, an intensity of ambient light directed by an optical sensor of the electronic device, to ambient light signals; determining, by the processor, whether an ambient light value has changed, based on to the ambient light signals; determining, by the processor, whether a change in the ambient light value is equal to or greater than a first predetermined value, if the ambient light value has changed, and in event turning off upon such determination.

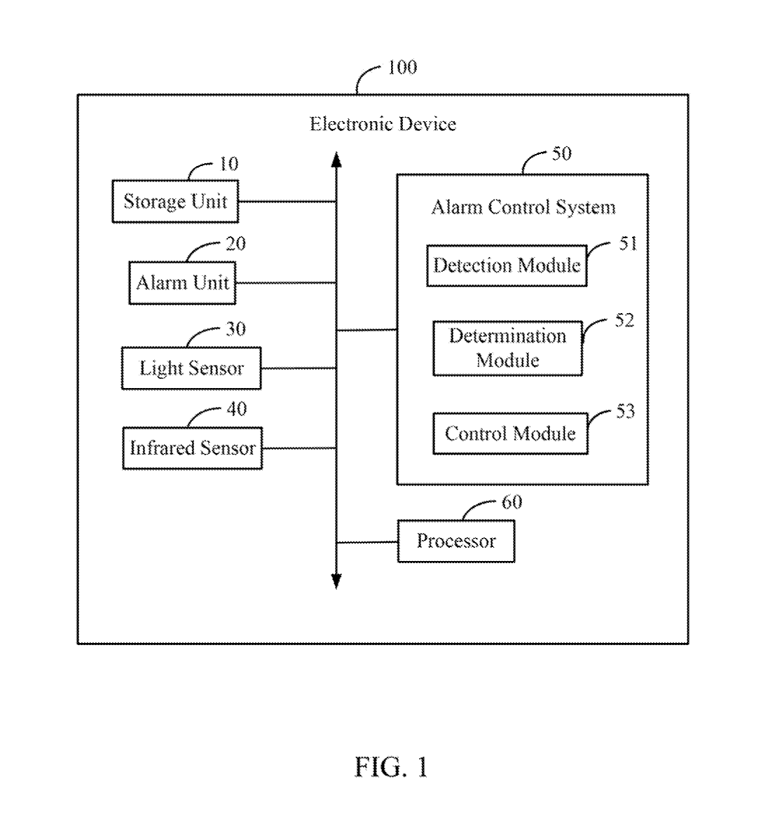

FIG. 1 is a block diagram of an example electronic device of the present disclosure. In at least the embodiment as shown in FIG. 1, an electronic device 100 includes, but is not limited to, a storage unit 10, an alarm unit 20, a light sensor 30, an infrared sensor 40, an alarm control system 50, and at least one processor 60. In at least one embodiment, the electronic device 100 can be a mobile phone, and the alarm unit 20 can be a loudspeaker. In an alternative embodiment, the alarm unit 20 also can include a speaker and a vibrator. FIG. 1 illustrates only one example of the electronic device that can include more or fewer components than illustrated, or have a different configuration of the various components in other embodiments. The electronic device 100 also can include other components, such as a keyboard and a camera.

In at least one embodiment, the storage unit 10 can include various types of non-transitory computer-readable storage mediums. For example, the storage unit 10 can be an internal storage system, such as a flash memory, a random access memory (RAM) for temporary storage of information, and/or a read-only memory (ROM) for permanent storage of information. The storage unit 10 can also be an external storage system, such as a hard disk, a storage card, or a data storage medium. The at least one processor 60 can be a central processing unit (CPU), a microprocessor, or other data processor chip that performs functions of the alarm control system 50 in the electronic device 100. The light sensor 30 can be an optical sensor.

In at least one embodiment, the alarm can be an audible alarm created by the speaker, a vibration alarm created by the vibrator, or include both audible alarm and the vibration alarm. When the alarm of the electronic device 100 is activated, whether day or night, no matter what the intensity of the prevailing ambient light where the electronic device 100 is located, the electronic device 100 can automatically turn off the alarm, as long as the neighborhood of the light sensor 30 and/or infrared sensor 40 are suddenly shielded.

The light sensor 30 and the infrared sensor 40 are arranged on the electronic device 100 and close to each other. In at least one embodiment, the light sensor 30 and the infrared sensor 40 are received in a groove defined on an upper shell of the electronic device 100, and the light sensor 30 and the infrared sensor 40 are aligned and close to each other.

In at least one embodiment, when the alarm of the electronic device 100 is activated, both the light sensor 30 and the infrared sensor 40 are also activated. The light sensor 30 senses the intensity of prevailing ambient light where the electronic device 100 is located, and the at least one processor 60 converts the sensed intensity to ambient light signals. In other words, the at least one processor 60 converts an intensity of ambient light directed by the light sensor 30 (eg. an optical sensor) of the electronic device 100 to ambient light signals. The infrared sensor 40 senses a change of infrared spectrum value, and the at least one processor 60 converts the sensed change of infrared spectrum value to infrared signals. In at least one embodiment, the infrared spectrum is the heat spectrum of the human body.

In an alternative embodiment, when the alarm of the electronic device 100 is activated, the light sensor 30 is also activated. The infrared sensor 40 is activated only when no light is sensed by the light sensor 30. In other words, when the alarm of the electronic device 100 is activated, the infrared sensor 40 is also activated only when there is no light around the electronic device 100, that is, when the electronic device 100 is in complete darkness. In any level of daylight, only the light sensor 30 is activated to save electrical power of the electronic device 100. In an alternative embodiment, the light sensor 30 and the infrared sensor 40 are both activated when the electronic device 100 is powered on.

The at least one processor 60 runs the alarm control system 50. The alarm control system 50 turns off the alarm if a change in the intensity of the ambient light sensed by the light sensor 30 is equal to or greater than a first predetermined value. In at least one embodiment, a user can shield the front of the light sensor 30 by his/her hand to cause the intensity change value to be equal to or greater than the first predetermined value. The alarm control system 50 also turns off the alarm if a change in the infrared spectrum value sensed by the infrared sensor 40 is equal to or greater than a second predetermined value. In at least one embodiment, a user can shield the front of the infrared sensor 40 by his/her hand to cause the change in the infrared spectrum change value to be equal to or greater than the second predetermined value. The first and second predetermined values are stored in the storage unit 10. The alarm control system 50 turns off the alarm based on the signals from the light sensor 30 and/or the infrared sensor 40.

In at least one embodiment, the alarm control system 50 can include a detection module 51, a determination module 52, and a control module 53. The function modules 51, 52, and 53 can include computerized codes in the form of one or more programs, which are stored in the storage unit 10. The at least one processor 60 executes the computerized codes to provide functions of the function modules 51-53.

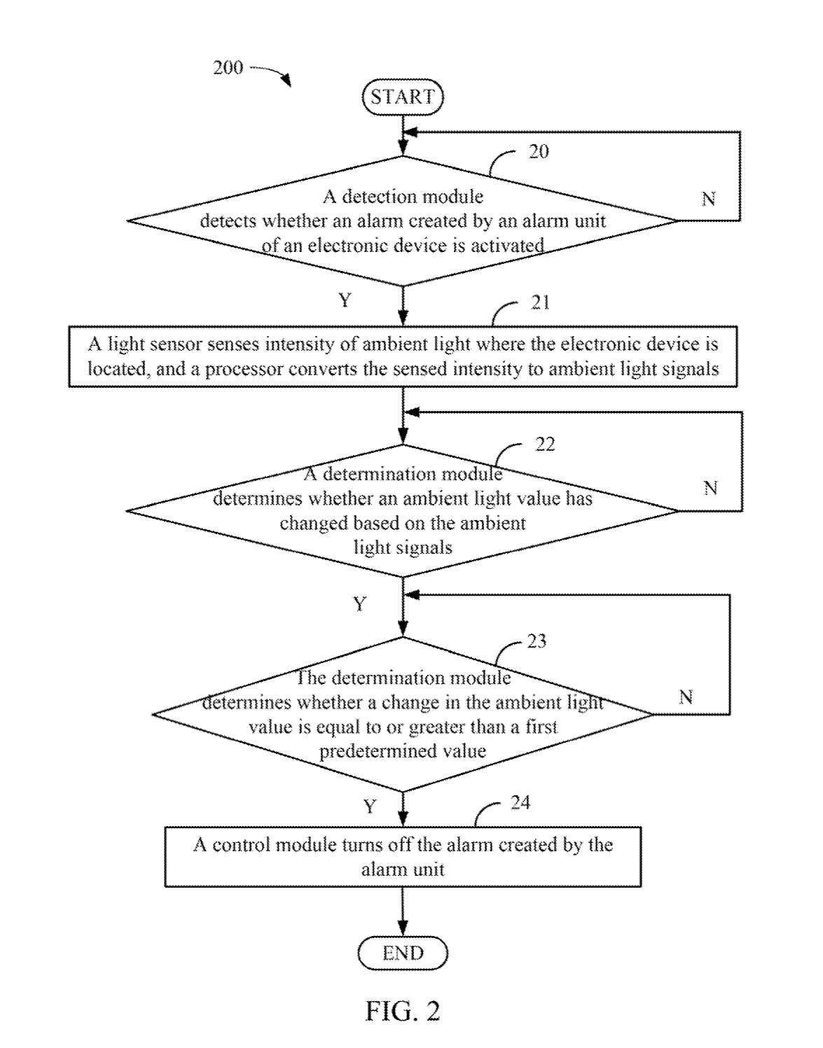

FIG. 2 is a flowchart of an alarm control method 200 for turning off an alarm for an electronic device that is presented in accordance with an example embodiment. A method 200 is provided by way of example, as there are a variety of ways to carry out the method. The method 200 described below can be carried out using the configurations illustrated in FIG. 1 and various elements of these figures are referenced in explaining example method 200. Each block shown in FIG. 2 represents one or more processes, methods, or routines, carried out in the exemplary method 200. Furthermore, the illustrated order of blocks is by example only and the order of the blocks can change. Additional blocks may be added or fewer blocks may be utilized, without departing from this disclosure. The exemplary method 200 can begin at block 20. Depending on the embodiment, additional steps can be added, others removed, and the ordering of the steps can be changed.

At block 20, a detection module detects whether an alarm created by an alarm unit of an electronic device is activated. If yes, block 21 is executed, otherwise, the method remains in block 20.

At block 21, a light sensor senses intensity of ambient light where the electronic device is located, and a processor converts the sensed intensity to ambient light signals. In an alternative embodiment, block 21 also includes: an infrared sensor sensing a change of infrared spectrum value, and a processor converting the sensed change of infrared spectrum value to corresponding signals. The infrared spectrum is the spectrum of human body temperature.

In an alternative embodiment, block 21 also includes: a determination module determining whether value of the prevailing ambient light sensed by the light sensor is lower than a threshold, and a control module activating an infrared sensor if the value of the prevailing ambient light value sensed by the light sensor is lower than a threshold. If the intensity of the ambient light is lower than the threshold, the changes caused by a shielding object(s) in front of the light sensor cannot be distinguished.

At block 22, a determination module determines whether an ambient light value has changed based on the ambient light signals. If yes, block 23 is executed, if no, block 21 is executed. In an alternative embodiment, block 22 also includes: a determination module determining whether the infrared spectrum value has changed based on the infrared signals. If yes, block 23 is executed, if no, block 21 is executed.

At block 23, the determination module determines whether the change in the ambient light value is equal to or greater than a first predetermined value. If yes, block 24 is executed, if no, block 23 is executed. In an alternative embodiment, block 23 also includes: the determination module continuing to determine whether the change in the infrared spectrum value is equal to or greater than a second predetermined value, if the change in the ambient light value is equal to or greater than the first predetermined value or the change in the infrared spectrum value is equal to or greater than a second predetermined value, block 24 is executed, otherwise, block 23 is executed.

At block 24, a control module turns off the alarm created by the alarm unit. In at least one embodiment, if the alarm unit is a loudspeaker, the control module turns off the speaker by turning off the sound. If the alarm unit is a vibrator, the control module turns off the vibrator. If the alarm unit includes a speaker and a vibrator, the control module turns off the speaker and the vibrator to turn off the sound alarm and the vibration alarm.

The embodiments shown and described above are only examples. Many details are often found in the art such as the other features of an electronic device and an alarm control method for turning off an alarm for the electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An alarm control method for turning off an alarm for an electronic device, the method comprising:
detecting, by a processor, that an alarm created by an alarm unit of an electronic device is activated;
converting, by the processor, an intensity of ambient light directed by an optical sensor of the electronic device, to ambient light signals;
determining, by the processor, whether an ambient light value has changed, based on to the ambient light signals; and
determining, by the processor, whether a change in the ambient light value is equal to or greater than a first predetermined value, if the ambient light value has changed; and in event turning off upon such determination.

2. The method as claimed in claim 1, further comprising:
sensing, by the optical sensor of the electronic device, the intensity of ambient light.

3. The method as claimed in claim 1, wherein the alarm is selected from the group consisting of:
a sound alarm created by a speaker of the alarm unit, and a vibration alarm created by a vibrator of the alarm unit.

4. The method as claimed in claim 1, further comprising:
converting, by the processor, changes of the infrared spectrum to corresponding infrared signals; and
determining, by the processor, whether a change of infrared spectrum value is equal to or greater than a second predetermined value, the infrared spectrum value has changed based on the infrared signals and in event turning off upon such determination.

5. The method as claimed in claim 4, further comprising:
sensing, by an optical sensor of the electronic device, the intensity of ambient light; and
sensing, by an infrared sensor of the electronic device, the change of infrared spectrum value.

6. The method as claimed in claim 4, wherein the alarm is selected from the group consisting of:
a sound alarm created by a speaker of the alarm unit, and a vibration alarm created by a vibrator of the alarm unit.

7. An alarm control method for turning off an alarm for an electronic device, the method comprising:
detecting, by a processor, that an alarm created by an alarm unit of an electronic device is activated;
converting, by the processor, an intensity of ambient light directed by an optical sensor of the electronic device, to ambient light signals;
determining, by the processor, whether a value of the intensity of ambient light is lower than a threshold;
activating, by the processor, an infrared sensor of the electronic device if the value of the intensity of ambient light is lower than a threshold;
converting, by the processor, infrared spectrum sensed by the infrared sensor, to corresponding infrared signals;
determining, by the processor, whether infrared spectrum value has changed based on the infrared signals; and
determining, by the processor, whether a change of the infrared spectrum value is equal to or greater than a second predetermined value if the infrared spectrum value has changed, and in event turning off upon such determination.

8. The method as claimed in claim 7, further comprising:
sensing, by an optical sensor of the electronic device, the intensity of ambient light; and
sensing, by the infrared sensor, the changes of infrared spectrum.

9. The method as claimed in claim 7, wherein the alarm is selected from the group consisting of:
a sound alarm created by a speaker of the alarm unit, and a vibration alarm created by a vibrator of the alarm unit.

10. The method as claimed in claim 7, wherein if the intensity of the ambient light is lower than the threshold, the brightness changes caused by object(s) in front of the optical sensor cannot be distinguished.

11. An electronic device, comprising:
an optical sensor, converting an intensity of ambient light directed by an optical sensor of the electronic device to ambient light signals;
a processor; and
a storage unit that stores one or more programs which, when executed by the a processor, cause the processor to:
detect that an alarm created by an alarm unit of an electronic device is activated;
determine whether an ambient light value has changed based on the ambient light signals; and
determine whether a change in the ambient light value is equal to or greater than a first predetermined value if the ambient light value has changed; and in event turn off upon such determination.

12. The electronic device as claimed in claim 11, wherein the optical sensor also senses the intensity of ambient light.

13. The electronic device as claimed in claim 11, wherein the alarm is selected from the group consisting of: a sound alarm created by a speaker of the alarm unit, and a vibration alarm created by a vibrator of the alarm unit.

14. The electronic device as claimed in claim 11, further comprises an infrared sensor for converting changes of the infrared spectrum to corresponding infrared signals; and the processor further determines whether an infrared spectrum value has changed based on the infrared signals, determines whether a change of the infrared spectrum value is equal to or greater than a second predetermined value if the infrared spectrum value has changed, and in event turns off upon such determination.

15. The electronic device as claimed in claim 14, wherein the optical sensor also senses the intensity of ambient light, and the infrared sensor also senses the changes of infrared spectrum.

16. The electronic device as claimed in claim 14, wherein the alarm is selected from the group consisting of: a sound alarm created by a speaker of the alarm unit, and a vibration alarm created by a vibrator of the alarm unit.

17. The electronic device as claimed in claim 14, wherein the processor further:
determines whether a value of the intensity of ambient light is lower than a threshold; and
activates the infrared sensor the electronic device if the value of the intensity of ambient light is lower than a threshold.

18. The electronic device as claimed in claim 17, wherein if the intensity of the ambient light is lower than the threshold, the brightness changes caused by object(s) in front of the optical sensor cannot be distinguished.

19. The electronic device as claimed in claim 11, being a mobile phone.
